(19) United States
(12) Patent Application Publication
(10) Pub. No.: US 2004/0019712 A1
(43) Pub. Date: Jan. 29, 2004

(54) Semiconductor device and method for controlling data transfer

(75) Inventor: Hiroshi Takase, Kasugai (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/621,462

(22) Filed: Jul. 18, 2003

(30) Foreign Application Priority Data
Jul. 18, 2002 (JP) 2002-209785

(51) Int. Cl. G06F 13/28

(52) U.S. Cl. 710/22

(57) ABSTRACT

A semiconductor device for efficiently transferring data of both digital and analog signals. The semiconductor device includes a digital interface for controlling input and output of a digital signal, an analog interface for controlling input and output of an analog signal, and a transfer controller. The transfer controller controls the transfer of data between the digital interface and the memory and between the analog interface and the memory. The data transferred between the analog interface and the memory is divided into plural pieces of data having a predetermined data length and converted to pseudo data packets.

### CROSS-REFERENCE TO RELATED APPLICATION

This application is based upon and claims the benefit of priority from Japanese Patent Application No. 2002-209785, filed on Jul. 18, 2002, the entire contents of which are incorporated herein by reference.

### BACKGROUND OF THE INVENTION

The present invention relates to a semiconductor device and a method for controlling data transfer. More particularly, the present invention relates to a semiconductor device for controlling data transfer between a computer and a plurality of peripheral devices.

Peripheral devices transfer digital signals or analog signals to a personal computer. For example, video cameras and televisions, which may function as peripheral devices of a computer, use analog signals. Accordingly, both digital and analog signals must be transferred efficiently between peripherals devices and a personal computer.

FIG. 1 is a schematic view showing a personal computer 51. A hard disk 52 and a video camera 53 are connected to the personal computer 51.

For example, an IEEE 1394 serial bus cable (hereinafter referred to as 1394 bus) 54 connects the personal computer 51 and the hard disk 52 to transfer data through digital signals. A coaxial cable 55 connects the personal computer 51 and the video camera 53 to transfer data through analog signals.

FIG. 2 is a schematic block diagram of a 1394 bus controller 61 and an AV (Audio/Video) I/F controller 62 in the prior art.

In the personal computer 51, the 1394 bus controller 61 and the AV I/F controller 62 are mounted on the same board 63. A system bus 64, which is configured, for example, by a Peripheral Components Interconnect (PCI) bus, connects each of the controllers 61 and 62 to a memory 65.

The 1394 bus controller 61 includes an 1394 interface 71, which has a physical layer (PHY) and a link layer (LINK), a receiving buffer 72, a transmitting buffer 73, a direct memory access controller (hereinafter simply referred to as DMA) 74, and a PCI bus master 75. The 1394 interface 71 is connected to the 1394 bus 54 (not shown in FIG. 2; shown in FIG. 1).

The 1394 bus controller 61 is in compliance with the 1394-1995 standard. The DMA 74 is in compliance with the 1394-OHCI (open host controller interface) standard, which defines the interface between the 1394 bus controller 61 and the personal computer 51 (specifically, an OS).

The DMA 74 performs asynchronous transfer or isochronous transfer in accordance with a context program stored in the memory 65. The context program includes various kinds of information, such as, the status of the DMA 74, the address at which the next program processed by the DMA 74 is stored, the address at which the packet data that is to be transmitted is stored, the length of the packet data, and the capacity of the memory 65.

In the DMA 74, channels are set for the transfer of request packets for asynchronous transfer, the transfer of response packets for asynchronous transfer, and the transfer of packets for isochronous transfer. At least four channels are set for the transfer of isochronous packets.

When performing isochronous transfer, the 1394 bus controller 61 uses one of the four channels of the DMA 74 to perform the transfer of packets.

More specifically, when transmitting isochronous packets, the DMA 74 reads the context program in the memory 65 via the PCI bus master 75. In accordance with the read program, the DMA 74 reads the data packet (packet data) having a header to which two quadlets of a packet header are added from the memory 65 and stores the read data packet in the transmitting buffer 73. The 1394 interface 71 reads the data packet from the transmitting buffer 73, converts the two quadlets of the packet header to one quadlet, and sends isochronous packets of serial data to the 1394 bus 54. The 1394-OHCI standard defines the packet format of the transmit data.

When receiving isochronous packets, the 1394 interface 71 receives isochronous packets of serial data from the 1394 bus 54 and converts the serial data to parallel data. Further, the 1394 interface 71 adds trailer data to the end of the data packet and stores the data packet in the receiving buffer 72. The DMA 74 reads the context program in the memory 65 via the PCI bus master 75 and stores the data packet of the receiving buffer 72 in the memory 65. The 1394-OHCI standard defines the packet format of the received data. The transfer between the 1394 interface 71 and the system bus 64 is performed in accordance with a transfer standard complying with the 1394-OHCI standard and 1394-1995 standard.

The AV I/F controller 62 includes an AV interface 81, a receiving buffer 82, a transmitting buffer 83, a controller 84, and a PCI bus master 85. The AV interface 81 is connected to an A/D converter and a D/A converter (not shown), which are mounted on the board 63, by a cable 55 (refer to FIG. 1).

In the AV I/F controller 62, when transmitting data, the controller 84 reads data, which is stored in the memory 65, from a predetermined address via the PCI bus master 85. The AV interface 81 reads data from the transmitting buffer 83 and converts the read data to an analog signal with the D/A converter (not shown). The analog signal is output via the cable 55.

When receiving data, the AV interface 81 converts the received analog signal to digital data with the A/D converter (not shown) and stores the digital data in the receiving buffer 82. The controller 84 reads the data from the receiving buffer 82 and stores the read data in the memory 65 at a predetermined address via the PCI bus master 85.

However, the mounting of the 1394 bus controller 61 and the AV I/F controller 62 on the board 63 increases the occupied area on the board 63. Further, when the interfaces 71 and 81 simultaneously transfer the digital and analog signals, the bandwidth of the system bus 64 in the personal computer 51 becomes insufficient. As a result, data cannot be efficiently transferred.

For example, referring to FIG. 3, the 1394 interface 71 receives a packet from the 1394 bus 54 when the AV interface 81 is transmitting data. In this state, however, the AV I/F controller 62 occupies the bandwidth of the system bus 64 (indicated by AV transmission in FIG. 3) to perform data transmission. Thus, the 1394 bus controller 61 cannot use the system bus 64. That is, the 1394 bus controller 61 cannot send the received packets to the system bus 64 to store the received data in the memory 65 until the AV I/F controller 62 completes the transmission of data. As a result, the 1394 bus controller 61 overflows. The same problem may also occur when the AV interface 81 receives data.

To prevent such overflow, the 1394 bus controller 61 may incorporate a buffer having a large capacity. However, a large capacity buffer would have a large chip area and would thus increase the occupied area on the board 63 and increase costs.

### SUMMARY OF THE INVENTION

One aspect of the present invention is a semiconductor device connected to a computer having a memory. The semiconductor device transfers data with a plurality of peripheral devices. The semiconductor device includes a digital interface for controlling input and output of a digital signal. An analog interface controls input and output of an analog signal. A transfer controller is connected to the memory via a bus and to the digital and analog interfaces. The transfer controller controls the transfer of data between the digital interface and the memory and between the analog interface and the memory.

Another aspect of the present invention is a semiconductor device connected to a computer having a memory. The semiconductor device transfers data with a plurality of peripheral devices. The semiconductor device includes a 1394 interface for controlling input and output of a digital signal. An AV interface controls input and output of an analog signal. A direct memory access controller is connected to the memory via a bus and to the 1394 and AV interfaces. The direct memory access controller controls the transfer of data performed by the interfaces. Further, the direct memory access controller divides the data the AV interface transmits to at least one of the peripheral devices into plural pieces of data having a predetermined data length and adding a packet header to each piece of data to generate a pseudo transmit data packet. A packet elimination circuit is connected to the direct memory access controller and the AV interface to eliminate the packet header from the pseudo transmit data packet when the direct memory access controller transfers the pseudo transmit data packet to the AV interface. A packet insertion circuit is connected to the AV interface and the direct memory access controller. The packet insertion circuit divides the data the AV interface receives from at least one of the peripheral devices into plural pieces of data having a predetermined data length and adds a packet header and trailer data to each piece of data to generate a pseudo receive data packet.

A further aspect of the present invention is a method for controlling data transfer with a semiconductor device connected to a computer having a memory. The semiconductor device includes an analog interface, which transfers data with a plurality of peripheral devices, and a transfer buffer. The method includes receiving data from at least one of the peripheral devices with the analog interface, storing the received data in the transfer buffer, dividing the stored data into plural pieces of data having a predetermined length, generating a pseudo data packet by adding a packet header and trailer data to each piece of data, and transferring the pseudo data packet to the memory.

A further aspect of the present invention is a method for controlling data transfer with a semiconductor device connected to a computer having a memory for storing data. The semiconductor device includes an analog interface, which transfers data with a plurality of peripheral devices, and a transfer buffer. The method includes reading data from the memory and dividing the read data into plural pieces of data having a predetermined length, generating a pseudo data packet by adding a packet header to each piece of data, transferring the pseudo data packet to the transfer buffer, eliminating the packet header from the pseudo data packet to store the data in the transfer buffer, and reading the data from the transfer buffer and transmitting the read data to at least one of the peripheral devices with the analog interface.

A further aspect of the present invention is a method for controlling data transfer with a semiconductor device connected to a computer having a memory. The semiconductor device is connected to the memory via a system bus and includes an analog interface, a first transfer buffer, and a second transfer buffer. The analog interface transfers data with a plurality of peripheral devices. The method includes receiving analog data from at least one of the peripheral devices and converting the analog data to first digital data with the analog interface, storing the first digital data in the first transfer buffer, dividing the first digital data into plural pieces of data having a predetermined length when transferring the stored first digital data to the memory, generating a pseudo receive data packet by adding a packet header and trailer data to each piece of the divided first digital data, transferring the pseudo receive data packet to the memory via the system bus, dividing second digital data stored in the memory into plural pieces of data having a predetermined data length, generating a pseudo transmit data packet by adding a packet header to each piece of the divided second digital data, transferring the pseudo transmit data packet to the second transfer buffer via the system bus, eliminating the packet header from the pseudo transmit data packet to store the second digital data in the second transfer buffer, and converting the second digital data stored in the second transfer buffer to analog data and transferring the analog data to at least one of the peripheral devices with the analog interface.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic view showing an example of a connection between a personal computer and peripheral devices;

FIG. 2 is a block diagram showing the configuration of an interface controller in the prior art;

FIG. 3 is a diagram showing the transition of the state of a system bus in the prior art;

FIG. 4 is a schematic block diagram showing the configuration of an interface controller according to a preferred embodiment of the present invention;

FIGS. 5A and 5B are diagrams illustrating the format of divided data in the preferred embodiment;

FIGS. 6A and 6B are timing charts showing the retrieval of data in the preferred embodiment; and

FIG. 7 is a diagram showing the transition of the state of a system bus in the preferred embodiment.

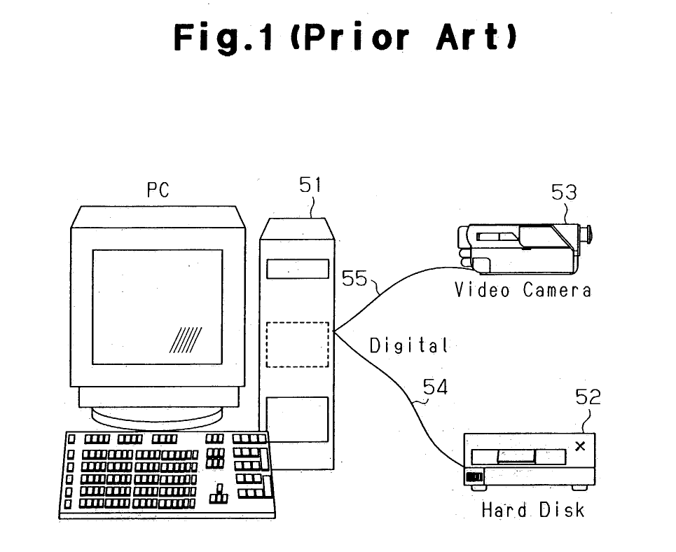

### DETAILED DESCRIPTION OF THE PREFERRED EMBODIMENTS

In the drawings, like numerals are used for like elements throughout.

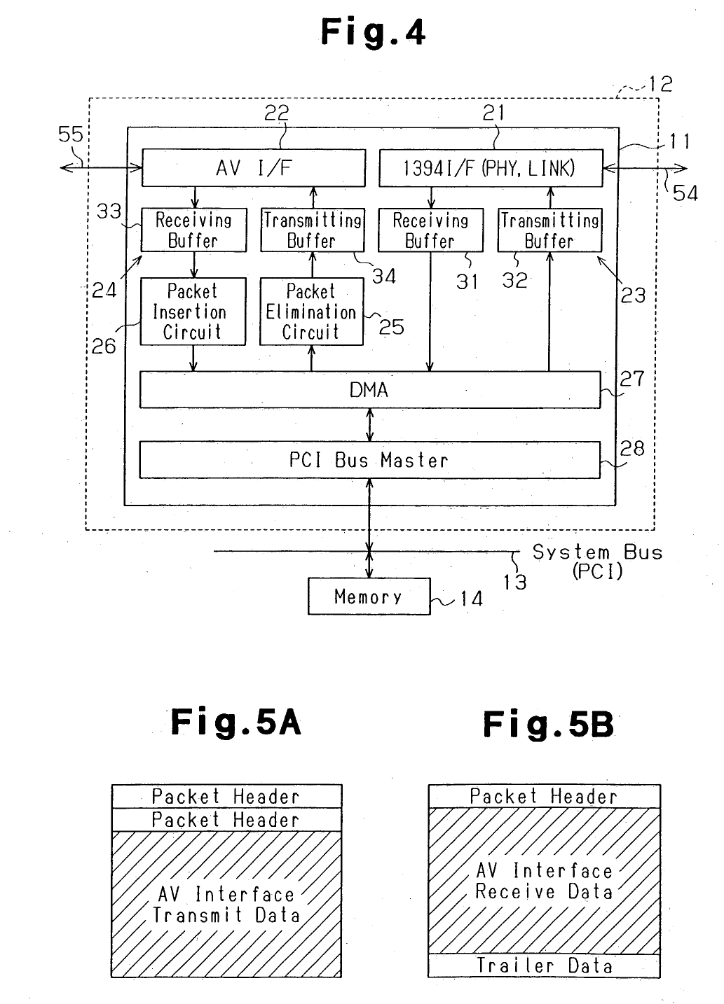

FIG. 4 is a schematic block diagram showing an interface (I/F) controller 11, which is a semiconductor device according to a preferred embodiment of the present invention. For example, the I/F controller 11 is incorporated in a personal computer 51, which is connected to a plurality of peripheral devices, such as a hard disk 52 and a video camera 53.

More specifically, the I/F controller 11 is mounted on a board 12, which is arranged in the personal computer 51. A system bus (PCI bus) 13 connects the I/F controller to a memory 14 in the personal computer 51. The I/F controller 11 includes a 1394 interface 21, which is a digital interface, an AV interface 22, which is an analog interface, a first transfer buffer 23, a second transfer buffer 24, a packet elimination circuit 25, a packet insertion circuit 26, a DMA controller (hereinafter simply referred to as DMA) 27 functioning as a transfer controller, and a PCI bus master 28.

The first transfer buffer 23, which is arranged between the 1394 interface 21 and the DMA 27, includes a receiving buffer 31 and a transmitting buffer 32 used to store the data transmitted and received by the 1394 interface 21. The second transfer buffer 24, which is arranged between the AV interface 22 and the DMA 27, includes a receiving buffer 33 and a transmitting buffer 34 used to store the data transmitted and received by the AV interface 22.

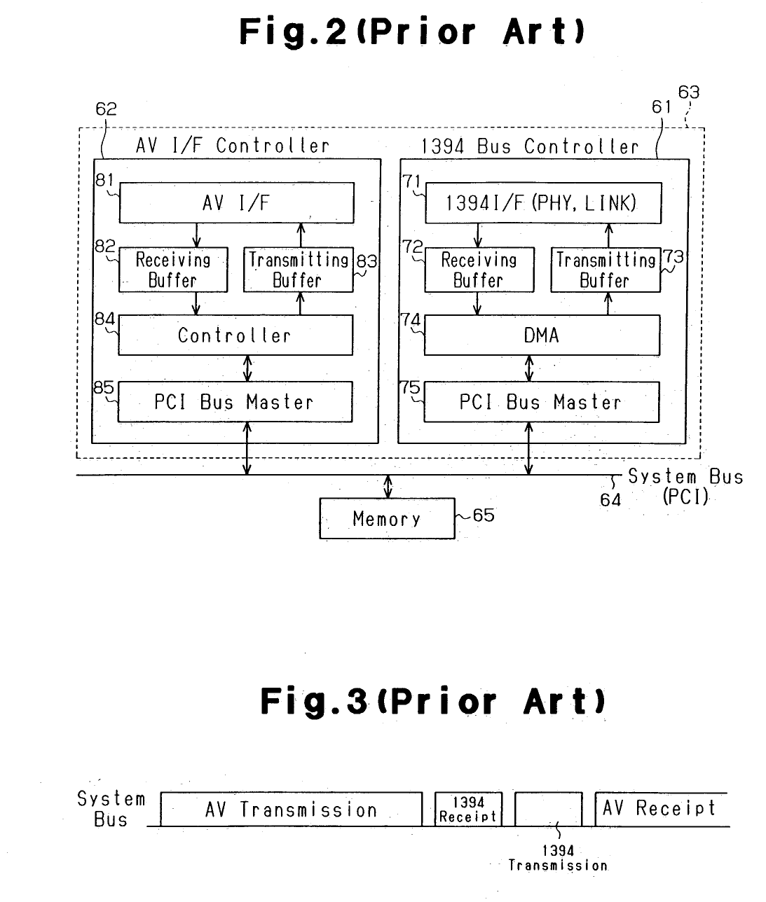

The 1394 interface 21 is connected to a 1394 bus 54, which connects the personal computer 51 and the hard disk 52. In the I/F controller 11, the 1394 interface 21, the receiving buffer 31, the transmitting buffer 32, and the PCI bus master 28 are configured in the same manner as the corresponding circuits 71 to 75 in the 1394 bus controller 61 of FIG. 2. That is, the I/F controller 11 (i.e., DMA 27) transfers data (packets) between the 1394 interface 21 and the system bus 13 in accordance with the 1394-1995 standard and the 1394-OHCI standard.

The AV interface 22, which includes an A/D converter and a D/A converter (not shown), are connected to a cable 55, which connects the personal computer 51 and the video camera 53, via the A/D converter and D/A converter. The AV interface 22, the receiving buffer 33, and the transmitting buffer 34 of the I/F controller 11 are configured in the same manner as the corresponding circuits 81 to 83 in the AV I/F controller of FIG. 2.

In the preferred embodiment, the DMA 27, which controls data transfer between the personal computer 51 and the hard disk 52, controls the transfer of data between the AV interface 22 and the system bus 13.

More specifically, among the four transmitting channels and four receiving channels used for isochronous transfer by the DMA 27, one of the transmitting channels and one of the receiving channels are allocated for the transfer of data between the AV interface 22 and the system bus 13. The memory 14 stores a context program, which is used to activate the allocated channel of the DMA 27 with the driver software (i.e., OS) of the personal computer 51. The DMA 27 transfers data between the AV interface 22 and the system bus 13 in accordance with the context program.

The transmission of an analog signal from the personal computer 51 to the video camera 53, or the transfer of transmit data from the system bus 13 to the AV interface 22, will now be discussed.

The DMA 27 reads the context program stored in the memory. Then, the DMA 27 reads the transmit data from the memory 14 via the PCI bus master in accordance with the context program. In this state, the DMA 27 reads the transmit data from the memory 14 in a state divided into data lengths corresponding to the isochronous packets. As shown in FIG. 5A, the DMA 27 adds two quadlets (eight bytes) of a packet header to the head of each piece of divided data.

Each of the two quadlets of the packet header added to the divided data includes information, such as the data length of the divided data and the transfer rate. The DMA 27 reads the packet headers from the memory 14 and adds the packet headers to the divided data to convert the transmit data to pseudo isochronous packets.

In accordance with the context program, the DMA 27 stores the transmit data (packet data) retrieved from the memory 14 in the transmitting buffer 34. In this state, the DMA 27 eliminates the two quadlet packet header added to the transmit data with the packet elimination circuit 25 and stores the transmit data from which the packet header has been eliminated in the transmitting buffer 34. More specifically, the packet header added when the DMA 27 retrieves the transmit data from the memory 14 is not required when data is output from the AV interface 22. Accordingly, the packet elimination circuit 25 eliminates the packet header from the transmit data.

The AV interface 22 reads the data from which the packet header has been eliminated from the transmitting buffer 34, converts the read data to an analog signal with a D/A converter (not shown), and provides the analog signal to the cable 55.

The receipt of an analog signal by the personal computer 51 from the video camera 53, or the transfer of receiving data from the AV interface 22 to the system bus 13, will now be discussed.

The AV interface 22 converts the analog signal transmitted from the video camera 53 to a digital signal with the A/D converter (not shown). Then, the AV interface 22 provides the digital signal to the receiving buffer 33.

The packet insertion circuit 26 divides the received data in the receiving buffer 33 into predetermined data lengths. More specifically, the packet insertion circuit 26 divides the received data in the receiving buffer 33 into data lengths corresponding to the isochronous packets. As shown in FIG. 5B, the packet insertion circuit 26 adds one quadlet (four bytes) of a packet header and one quadlet of trailer data to the head and end of each piece of divided data.

The packet header added to the data includes information of the data length of the divided data. The packet insertion circuit 26 converts the received data in the receiving buffer 33 to pseudo isochronous packets.

In accordance with the context program stored in the memory 14, the DMA 27 reads the converted received data (data packet) from the receiving buffer 33. Then, the DMA 27 stores the read received data in the memory 14 via the PCI bus master 28.

In this state, the DMA 27 may use the packet header elimination function of the DMA 27 that is regulated by the 1394-OHCI standard to eliminate the packet header and trailer data added to the received data. Further, the DMA 27 may store the received data from which the packet header and trailer data have been eliminated in the memory 14.

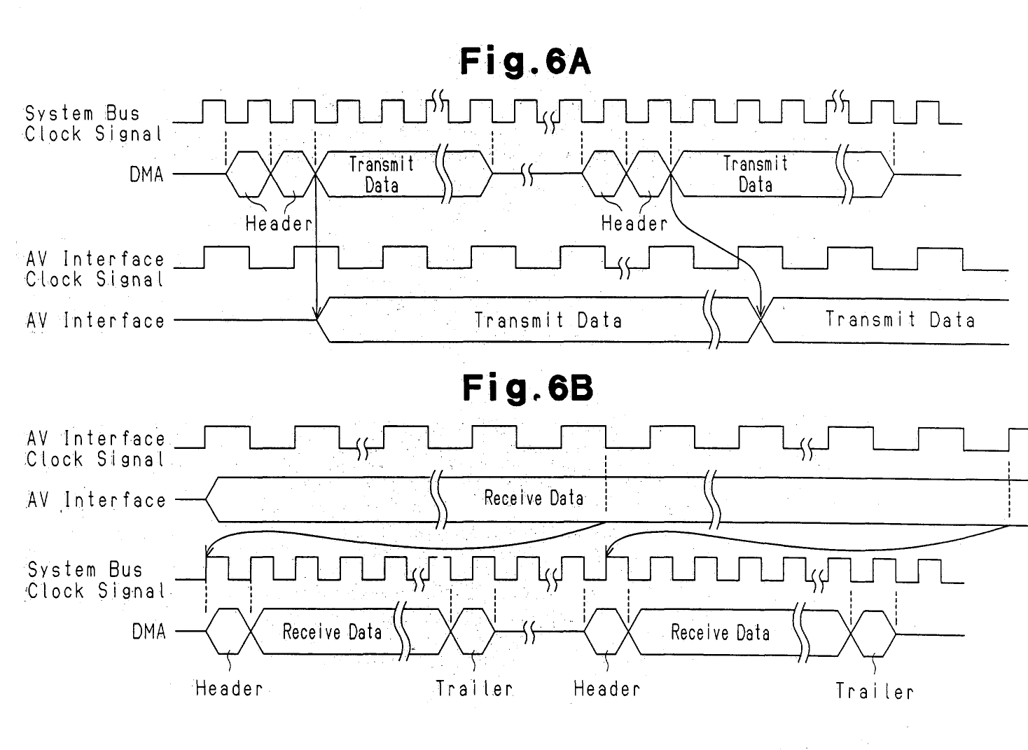

FIGS. 6A and 6B are timing charts showing the retrieval of data between the AV interface 22 and the system bus 13. The retrieval of the transmit data will first be discussed with reference to FIG. 6A.

The DMA 27 reads the transmit data, or the pseudo isochronous packets, from the memory 14 in accordance with a clock signal (hereinafter referred to as system clock signal), which is used to drive the system bus 13. When storing the two quadlet packet header in the transmitting buffer 34, the packet elimination circuit 25 masks a write enable signal, which is used to write data to the transmitting buffer 34, to invalidate the packet header. Then, the DMA 27 stores only the data from which the packet header has been eliminated in the transmitting buffer 34.

Subsequently, the AV interface 22 reads data (the data from which the packet header has been eliminated) from the transmitting buffer 34 in accordance with a clock signal (hereinafter referred to as an AV interface clock signal), which drives the AV interface 22. As shown in FIG. 6A, the transfer rate of the system bus clock is higher than that of the AV interface clock signal. Accordingly, the divided packet data read by the DMA 27 is output from the AV interface 22 as substantially continuous data.

The retrieval of the received data will now be discussed with reference to FIG. 6B. The AV interface 22 stores the received data in the receiving buffer 33 in accordance with the AV interface clock signal via the A/D converter (not shown).

The packet insertion circuit 26 adds one quadlet of a packet header and one quadlet of trailer data to the received data in the receiving buffer 33 to generate pseudo isochronous packets. Then, the DMA 27 reads the data packet from the receiving buffer 33 in accordance with the clock signal of the system bus 13.

More specifically, when the DMA 27 reads data from the receiving buffer 33, the packet insertion circuit 26 adds one quadlet of a packet header to the received data. After the DMA 27 reads data corresponding to the data length of the isochronous packet from the receiving buffer 33, the packet insertion circuit 26 adds one quadlet of trailer data to the received data. In this manner, the DMA 27 reads the data received by the AV interface 22 from the receiving buffer 33 as a pseudo isochronous packet.

As shown in FIG. 6B, due to the difference in transfer rate between the system bus clock signal and the AV interface clock signal, the packet insertion circuit 26 has enough time for inserting the packet header and the trailer data to the data received by the AV interface 22.

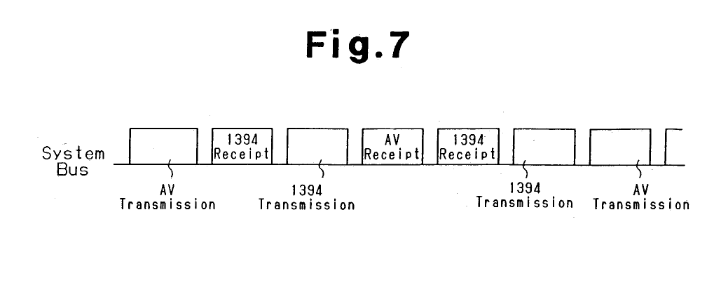

FIG. 7 is a diagram showing the transition of the state of the system bus 13 when using the I/F controller 11 of the preferred embodiment.

When the I/F controller 11 uses the bandwidth of the system bus 13 to transmit data from the AV interface 22 (AV transmission in FIG. 7), the I/F controller 11 converts the data transmitted from the AV interface 22 to pseudo isochronous packets. Then, the I/F controller 11 transfers the isochronous packets retrieved from the memory 14 to the AV interface 22.

Accordingly, when the 1394 interface 21 receives data before the transfer processing of the data that is to be transmitted from the AV interface 22 is completed, the I/F controller 11 uses the system bus 13 to store the data received by the 1394 interface 21 in the memory 14 (1394 receipt in FIG. 7).

When the 1394 interface 21 transmits data before the transfer processing of the data that is to be transmitted from the AV interface 22 is completed, the I/F controller 11 uses the system bus 13 to retrieve the data transmitted from the 1394 interface 21 from the memory 14 (1394 transmission in FIG. 7).

Further, when the AV interface 22 receives data before the transfer processing of the data that is to be transmitted from the AV interface 22 is completed, the I/F controller 11 uses the system bus 13 to store the received data in the memory 14 (AV receipt in FIG. 7). When doing so, the I/F controller 11 converts the data received by the AV interface 22 to pseudo isochronous packets and stores the isochronous packets in the memory 14.

In the preferred embodiment, the DMA 27 performs data transfer between the AV interface 22 and the system bus 13 with isochronous packets. This enables the DMA 27 to control the data transfer between the 1394 interface and the AV interface 22 in accordance with the occupied rate of the bandwidth of the system bus 13. In other words, the DMA 27 secures the bandwidth of the system bus 13 used for transfer in accordance with the transfer state of both 1394 and AV interfaces 21 and 22.

The I/F controller of the preferred embodiment has the advantages described below.

(1) The I/F controller includes the 1394 interface 21, which controls the input and output of digital signals, the AV interface 22, which controls the input and output of analog signals, and the DMA 27, which controls the transfer of data between the system bus 13 and the interfaces 21 and 22. The channel of the DMA 27 is allocated for the data transfer between the AV interface 22 and the system bus 13. Further, the DMA 27 uses the pseudo isochronous packets when transferring data. This reduces the data transferred between the AV interface 22 and the system bus 13. Accordingly, the DMA 27 transfers data between the system bus 13 and the 1394 and AV interfaces 21 and 22 in accordance with the occupied rate of the bandwidth of the system bus 13. This improves the efficiency for transferring data between the personal computer 51 and the plurality of peripheral devices (e.g., the hard disk 52 and the video camera 53) and enables substantially simultaneous data transfer between the personal computer 51 and the peripheral devices.

(2) The transfer of data between the AV interface 22 and the system bus 13 is performed using the pseudo isochronous packets. Thus, even if the 1394 interface 21 and the AV interface 22 perform data transfer at the same time, the overflow of the transfer data due to insufficient bandwidth of the system bus 13 does not occur. In other words, the bandwidth of the system bus 13 is prevented from being occupied for a long time by the data transfer performed between the AV interface 22 and the system bus 13. Thus, overflowing is prevented in the receiving buffer 31, which stores the data received by the 1394 interface 21. Accordingly, the I/F controller 11 does not require the receiving buffer 31 to have a large capacity.

(3) The channels of the DMA 27 are allocated for the data transfer between the AV interface 22 and the system bus 13, and the data transfer of the 1394 interface 21 and the data transfer of the AV interface 22 are both controlled by the same DMA 27. This decreases the number of circuit devices configuring the I/F controller 11. Further, the circuit scale may be decreased. This reduces the occupied area on the board 12, such as a mother board or an add-in card.

It should be apparent to those skilled in the art that the present invention may be embodied in many other specific forms without departing from the spirit or scope of the invention. Particularly, it should be understood that the present invention may be embodied in the following forms.

The 1394 interface 21 may be another type of digital interface, such as a USB interface. Further, another type of analog interface may be another type of analog interface. By converting the data processed by the DMA 27 to pseudo data that can easily be controlled by the DMA 27 during the transfer of data between an analog interface and the system bus 13, the same advantages as those of the preferred embodiment are obtained.

In the preferred embodiment, the DMA 27 employs the bus master technique to access the memory 14 on the system bus 13 (PCI bus) via the PCI bus master 28. However, the DMA 27 does not necessarily have to employ the bus master technique. Further, the system bus 13 is not limited to the PCI bus.

The present examples and embodiments are to be considered as illustrative and not restrictive, and the invention is not to be limited to the details given herein, but may be modified within the scope and equivalence of the appended claims.

What is claimed is:

1. A semiconductor device connected to a computer having a memory, wherein the semiconductor device transfers data with a plurality of peripheral devices, the semiconductor device comprising:
a digital interface for controlling input and output of a digital signal;
an analog interface for controlling input and output of an analog signal; and
a transfer controller connected to the memory via a bus and to the digital and analog interfaces, wherein the transfer controller controls the transfer of data between the digital interface and the memory and between the analog interface and the memory.

2. The semiconductor device according to claim 1, wherein the data transferred between the analog interface and the memory is divided into plural pieces of data having a predetermined data length.

3. The semiconductor device according to claim 1, further comprising:
a packet insertion circuit connected to the analog interface and the transfer controller, wherein the packet insertion circuit divides the data the analog interface receives from at least one of the peripheral devices into plural pieces of data having a predetermined data length and adds a packet header and trailer data to each piece of data to generate a pseudo receive data packet, the transfer controller providing the pseudo receive data packets to the memory via the bus.

4. The semiconductor device according to claim 1, wherein the transfer controller divides the data the analog interface transmits to at least one of the peripheral devices into plural pieces of data having a predetermined data length and adds a packet header to each piece of data to generate a pseudo transmit data packet.

5. The semiconductor device according to claim 4, further comprising:
a packet elimination circuit connected to the transfer controller and the analog interface to eliminate the packet header from the pseudo transmit data packet.

6. The semiconductor device according to claim 5, wherein the memory stores a context program including information related with packet transfer, and the transfer controller generates the pseudo transmit data packet in accordance with the context program.

7. The semiconductor device according to claim 1, further comprising:
a plurality of channels for the transfer controller to transfer data between the digital interface and the bus, wherein at least one of the channels is allocated for transmitting data and one of the channels is allocated for receiving data when the transfer controller transfers data between the analog interface and the bus.

8. The semiconductor device according to claim 1, the digital interface is one of a plurality of digital interfaces, and the analog interface is one of a plurality of analog interfaces.

9. A semiconductor device connected to a computer having a memory, wherein the semiconductor device transfers data with a plurality of peripheral devices, the semiconductor device comprising:
a 1394 interface for controlling input and output of a digital signal;
an AV interface for controlling input and output of an analog signal;
a direct memory access controller connected to the memory via a bus and to the 1394 and AV interfaces, wherein the direct memory access controller controls the transfer of data performed by the interfaces, the direct memory access controller dividing the data the AV interface transmits to at least one of the peripheral devices into plural pieces of data having a predetermined data length and adding a packet header to each piece of data to generate a pseudo transmit data packet;
a packet elimination circuit connected to the direct memory access controller and the AV interface to eliminate the packet header from the pseudo transmit data packet when the direct memory access controller transfers the pseudo transmit data packet to the AV interface; and
a packet insertion circuit connected to the AV interface and the direct memory access controller, wherein the packet insertion circuit divides the data the AV interface receives from at least one of the peripheral devices into plural pieces of data having a predetermined data length and adds a packet header and trailer data to each piece of data to generate a pseudo receive data packet.

10. The semiconductor device according to claim 9, further comprising:
a plurality of channels for the direct memory access controller to transfer data between the 1394 interface and the bus, wherein at least one of the channels is allocated for transmitting data and one of the channels is allocated for receiving data when the direct memory access controller transfers data between the AV interface and the bus.

11. The semiconductor device according to claim 9, wherein the memory stores a context program including information related with packet transfer, and the direct memory access controller generates the pseudo transmit data packet in accordance with the context program.

12. A method for controlling data transfer with a semiconductor device connected to a computer having a memory, wherein the semiconductor device includes an analog interface, which transfers data with a plurality of peripheral devices, and a transfer buffer, the method comprising:
receiving data from at least one of the peripheral devices with the analog interface;
storing the received data in the transfer buffer;
dividing the stored data into plural pieces of data having a predetermined length;
generating a pseudo data packet by adding a packet header and trailer data to each piece of data; and
transferring the pseudo data packet to the memory.

13. The method according to claim 12, further comprising:
eliminating the packet header and the trailer data when storing the pseudo data packet in the memory.

14. The method according to claim 12, wherein the semiconductor device includes a digital interface for transferring data with the peripheral devices, and a plurality of channels for transferring data between the digital interface and the bus, the method further comprising:
transferring the pseudo data packet to the memory from the buffer with at least one of the plurality of channels.

15. A method for controlling data transfer with a semiconductor device connected to a computer having a memory for storing data, wherein the semiconductor device includes an analog interface, which transfers data with a plurality of peripheral devices, and a transfer buffer, the method comprising:
reading data from the memory and dividing the read data into plural pieces of data having a predetermined length;
generating a pseudo data packet by adding a packet header to each piece of data;
transferring the pseudo data packet to the transfer buffer;
eliminating the packet header from the pseudo data packet to store the data in the transfer buffer; and
reading the data from the transfer buffer and transmitting the read data to at least one of the peripheral devices with the analog interface.

16. The method according to claim 15, wherein the semiconductor device includes a digital interface for transferring data with the peripheral devices, and a plurality of channels for transferring data between the digital interface and the bus, the method further comprising:
transferring the pseudo data packet to the transfer buffer from the memory with at least one of the plurality of channels.

17. A method for controlling data transfer with a semiconductor device connected to a computer having a memory, wherein the semiconductor device is connected to the memory via a system bus and includes an analog interface, a first transfer buffer, and a second transfer buffer, wherein the analog interface transfers data with a plurality of peripheral devices, the method comprising:
receiving analog data from at least one of the peripheral devices and converting the analog data to first digital data with the analog interface;
storing the first digital data in the first transfer buffer;
dividing the first digital data into plural pieces of data having a predetermined length when transferring the stored first digital data to the memory;
generating a pseudo receive data packet by adding a packet header and trailer data to each piece of the divided first digital data;
transferring the pseudo receive data packet to the memory via the system bus;
dividing second digital data stored in the memory into plural pieces of data having a predetermined data length;
generating a pseudo transmit data packet by adding a packet header to each piece of the divided second digital data;
transferring the pseudo transmit data packet to the second transfer buffer via the system bus;
eliminating the packet header from the pseudo transmit data packet to store the second digital data in the second transfer buffer; and
converting the second digital data stored in the second transfer buffer to analog data and transferring the analog data to at least one of the peripheral devices with the analog interface.

18. The method according to claim 17, wherein the semiconductor device includes a digital interface for transferring data with the peripheral devices and a plurality of channels to transfer data between the digital interface and the system bus, the method further comprising:
transferring the pseudo receive data packet from the first transfer buffer to the system bus with at least one of the plurality of channels.

19. The method according to claim 17, further comprising:
eliminating the packet header and the trailer data when storing the pseudo receive data packet in the memory.

20. The method according to claim 17, wherein the memory includes context program, said generating a pseudo transmit data packet includes generating the pseudo transmit data packet in accordance with the context program.
